(19) United States
(12) Patent Application Publication
(10) Pub. No.: US 2022/0346349 A1
(43) Pub. Date: Nov. 3, 2022

(54) METHOD AND APPARATUS OF USING A CELLULAR NETWORK TO SCHEDULE AND MOVE MATERIAL FROM A FIRST LOCATION TO A SECOND LOCATION

(71) Applicants: Paul Miller, Sugarcreek, OH (US); Jim Beckford, Barberton, OH (US)

(72) Inventors: Paul Miller, Sugarcreek, OH (US); Jim Beckford, Barberton, OH (US)

(21) Appl. No.: 17/244,423

(22) Filed: Apr. 29, 2021

(51) Int. Cl. A01K 5/02; H04L 29/08

(52) U.S. Cl. CPC A01K 5/0291; A01K 5/0258; H04L 67/025

(57) ABSTRACT

A method and apparatus for remotely controlling the selective delivery of an associate material from a first location to a second desirable location as provided. A primary application of the method and apparatus is the remote control of the delivery of deer food by a deer feeder for the purposes of hunting deer.

### I. BACKGROUND

### A. Field of the Invention

This invention generally relates to methods and apparatuses related to moving material, such as granular products, fluids, or slurries such as food, from a first location to a second location, and more specifically to methods and apparatuses of accomplishing this effect via remote control, and even more specifically to accomplishing these actions through remote control through a cellular network where the apparatuses are connected to the control system via a cellular network.

### B. Description of Related Art

It is known in the art for certain methods and apparatuses to provide materials from a first location to a second location at specific times in response to a signal of some sort. The user uses the app on their smart phone to communicate over a wireless link to the cellular network. The cellular network communicates to the cloud which is responsible for routing the information to a) the internet for access by a web browser or b) elsewhere on the cellular network which will then wirelessly communicate to the controller which is wired to the delivery mechanism.

What is needed is a method of monitoring and controlling the delivery of such materials via an app on a smart phone, communicating over a wireless link to the cellular network. The cellular network communicates to the cloud which is responsible for routing the information to a) the internet for access by a web browser or b) elsewhere on the cellular network which will then wirelessly communicate to the controller which is wired to the delivery mechanism. This invention will provide numerous other advantages as well as to be understood by person of ordinary skill in the art.

### II. SUMMARY

According to some embodiments of this invention, an apparatus comprises a source of an associated material, such as food, or more preferably, deer food. A transport means for transporting the associated material from a first location to a second location as provided and specifically this transport means could be an auger which is operatively associated with a motor which can selectively cause the auger to turn. Alternatively, rather than an auger, a pump, siphon, a system using a spinner, or gravity feed can also work, when chosen with sound engineering judgment. When the auger turns, associated material, such as deer food is transported from a first location (such as a receptacle,) to a second location (such as the ground) or another container, where the deer can eat the food.

According to a still further aspect of the invention, a controller can operatively associate with the transport means, or with the source of the associated material. The source of the material could be a receptacle or a container of some sort, such as it might be appropriate for a containing grainer material, such as sand, or food, such as deer food.

According to a still further aspect of the invention, a controller comprises a camera function, wherein the controller is of taking, transmitting, and storing onto a memory card or circuit visual images and video. The user or hunter can later retrieve the images or video, or transmit them.

According to a still further aspect of the invention, the monitoring and controlling the delivery of materials via an app on a smart phone is provided, with the monitoring and controlling being carried out by communicating over a wireless link to a cellular network. The cellular network communicates to the cloud which is responsible for routing the information to a) the internet for access by a web browser or b) elsewhere on the cellular network which will then wirelessly communicate to the controller which is wired to the delivery mechanism. The controller can be operated by linking to a wireless network, such as the Internet of Things (“IoT”), or a cellular network, or some other way to operatively connect the controller to the apparatus. In one preferred embodiment, once the controller is programmed, no such connection (controller to cellular network and possibly user) is needed, but a connection may be needed to change the programming of the controller. No button or display is required on the timer/controller. Further, the user can configure the controller remotely via accessing the cloud, a private data store and control accessible using the internet. All wireless connection to the controller goes through the cloud whether it originates from the user's smart phone or an internet browser.) The controller can generate status reports of each scheduled or timed event. Once programed, the controller can operate without operative access to the internet or cellular network.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic, perspective view of an apparatus according to the invention.

FIG. 2 is a top perspective view of an intermediate member of the apparatus according to the invention.

FIG. 3 is a top perspective view of a motor attaching to an auger of the apparatus according to the invention.

FIG. 4 is a schematic view of an apparatus according to the invention showing a satellite, telephone or other wireless connection, a controller and an associated deer.

### IV. DETAILED DESCRIPTION

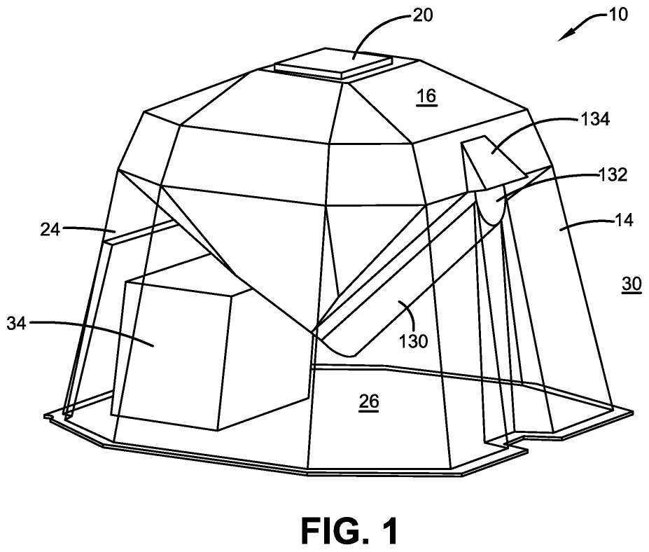

Referring now to the drawings wherein the showings are for purposes of illustrating embodiments of the invention only and not for purposes of limiting the same, and wherein like reference numerals are understood to refer to like components, FIGS. 1-4 show the method and apparatus to the invention. Specifically, with reference to FIG. 1, in apparatus 10, according to the invention as shown. While the apparatus 10 may take various forms, a currently preferred form, shown in perspective, schematic, “See-through” view an apparatus includes a shell 14, which provides overall protection from the elements for the things contain therein. In the preferred embodiment illustrated in FIG. 1, the shell has several components including a cap 16, which comprises a variety of planar surfaces. One of those planar surfaces is at the apex of the cap and is a square member 20. The shell 14 also includes generally vertically displaced wall members.

With continue reference to FIG. 1, the cap 16 and wall members 24 define an interior space 26 and an exterior space 30. The interior space 26 is convenient for the storage of various useful items. In the application of deer hunting, the interior space provides an excellent place to store gear, ammunition, food, and the like.

With continue reference to FIG. 1, convenient and useful use of the interior space 26 as a storage of food stuffs in a larger generally rectangular cubic storage unit 34. A variety of the materials can be stored inside the storage unit 34, but one good thing to store would be the material which is later to be distributed or moved from a first location to a second location.

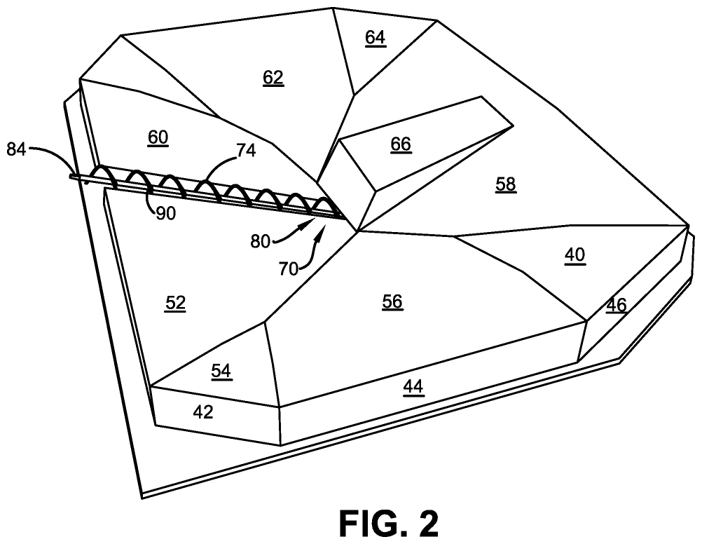

With reference to FIG. 2, a portion of the apparatus 10 is shown. Specifically, the intermediate member 40 is generally displaced at a horizontal or initiation. The edges 42, 44 and 46 of the intermediate member 40 are generally vertically orientated and can receive thereupon in frictional engagement cap member 16.

With continuing reference to FIG. 2, note that interior generally planar surfaces 52, 54, 56, 58, 60, 62, 64, 66 slant inwardly toward a low point 80.

With continuing reference to FIG. 2, at the low point, a transport means 74 is preferably located. The first end of the transport means 76 is near the low point 80, while the second end of the transport means is located outside of the shell 84. In other embodiments of the invention, the transport means could be a pump, siphon, a system using a spinner, or gravity feed can also work, when chosen with sound engineering judgment.

With continuing reference to FIG. 2, the preferred transport means 74 is an auger 90. However, note the invention is not limited to the transport means being an auger. Rather, an auger, a pump, siphon, a system using a spinner, or gravity feed or gravity slide can also work, when chosen with sound engineering judgment.

With continuing reference to FIG. 2, the interior surface 66 covers a motor (not shown) which is operatively associated with the first end 80 of the auger 90. When the motor is activated, it causes the auger to turn in any granular material, such as deer food, which might be stored atop of the interior surfaces 52-68 will, by the force of gravity, matriculate to the low point 70. At such time, the food stuffs or materials will become engaged with the auger and as the auger turns, the food stuff will be transported upwardly along the center line of the auger until they leave the interior space 26 of the apparatus 10 and fall onto a second desired location, in this case, the ground. Therefore, the apparatus 10 is effective to selectively transport material, such as deer food, from a first location (such as the interior space 26) to a second location (the associated outside surface of the ground) outside the apparatus 10.

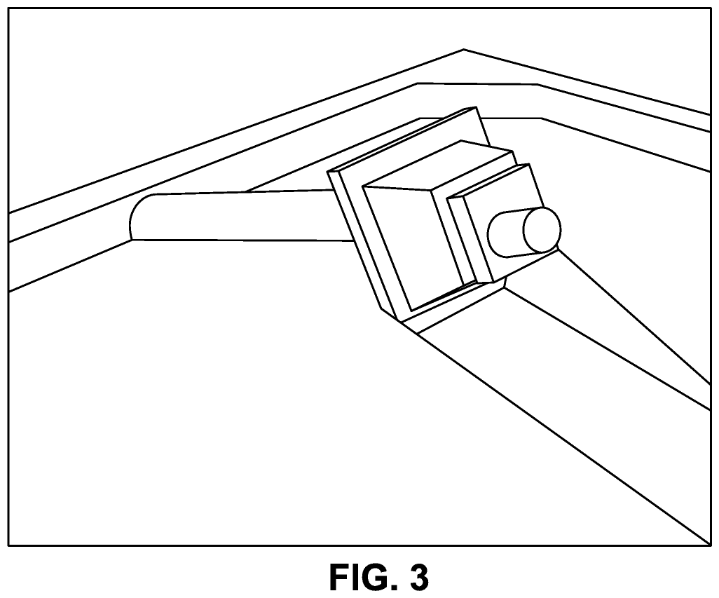

With reference to FIG. 3, the motor and auger connection is illustrated.

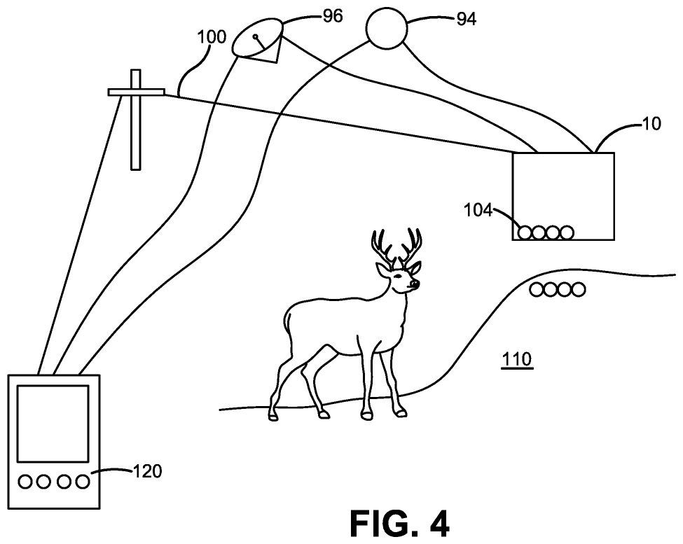

With reference to FIG. 4, a schematic view of the method and apparatus and its operation is shown. It is known for materials to be transported from a first desired location to a second location via transport means. It is also known to control such movement via controller. However, some of the attributes of the system described herein, have not previously been known and will not be described. In a preferred application, the material to be moved is deer food and the application is deer hunting. However, this invention, and the wireless control of the movement material from one location to another has applicability to other applications other than deer hunting. However, from this point forward, the invention will be described in the context of deer hunting.

With continuing reference to FIGS. 1-4, it is common for a deer hunter to have a certain location at which he wishes to hunt deer. This location may be set by the hunters own private property or has access to the private property of another. Another option might be through a deer lease or the like, but in any event, there are certain locations where a hunter wishes to hunt deer. However, the deer may not be at that location at the time when the hunter wishes to hunt. One way to increase the likelihood of deer at the location or at a certain time, is to provide food for the deer. However, since deer hunting is often done at locations remote from where the hunter lives and works, this creates challenges. For example, a deer hunter may reside several hours away from the location at which he wishes to attract the deer. How can the deer hunter provide food in an intelligent, effective way from a remote location? One solution is provided herein. Shown schematically in FIG. 4, the apparatus 10 is operatively connected wirelessly to a satellite 94, dish 96, or other source of wireless data, such as cable lines 100. In any event, the signals necessary to control the apparatus 10 can be wirelessly transmitted to the apparatus 10 via a variety of wireless methods including the internet of things or partially hardwired through cable lines, telephone lines or the like. Inside the apparatus 10, is stored the material to be transferred, in this case associated deer food 104. At certain advantageous rates and time, the associated deer food 104 must be moved from the interior of the apparatus to the exterior and placed on the associated ground 110. By moving the deer food from the interior of the apparatus to the ground 110, the associated deer food can attract the associated 112.

With continuing reference to FIGS. 1-4, how could control be done. With reference to FIG. 4, a controller 120 is shown. In the preferred embodiment, the controller 120 is a smart phone having internet access through a cellular network, such as those currently sold by a third-party company such as Verizon, ATT, T-Mobile, etc. On the controller 120 will reside in the memory, an app. The signals come from the cellular network. The controller 120 communicates through the cellular network to the smart phone, from the apparatus 10 to provide information about the following representative list of conditions: level of food in the apparatus, level of food on the ground, digital images of the environment around the apparatus, such as the presence of deer food on the ground or the presence of deer moving near the food, movement by animals, such as deer, near the apparatus, the time when each of the aforementioned activities occur, environmental conditions near the apparatus, such as level of light, ambient temperature, moisture and humidity levels and sound. This data is transmitted wirelessly through the mechanisms already mentioned to the app on the smartphone/controller 120. The hunter, who has the smartphone with him remote from the apparatus 10, can monitor the status of the situation near the apparatus. The hunter can note whether there is animal activity and movement, the level of light, the level of food both within and without the apparatus and whether the atmosphere of conditions near the apparatus are conducive to hunting. The apparatus can be programmed to deliver the food at a certain rate. The timed delivery occurs whether or not the controller is connected to the cell network. Programming of the controller requires connection of the phone and the controller to the cell network. For example, in one phase of operation, the controller can set a certain timed delivery of food so that the apparatus delivers the food according to the previously designed schedule. This feature can be accomplished whether or not the apparatus is online and connected to the internet of things. However, in a second application, the apparatus 10 is continuously connected to the internet of things and is not only transmitting data but receiving instructions from the controller, including commands to deliver food, through the app on the smartphone.

With continuing reference to FIG. 1, a generally cylindrical shoot 130 whose longitudinal access generally coincides with that of the auger 90 contains the auger. A selectively openable door 130 or flap 132 is preferably hinged at the top and can selectively open when material, such as the associated deer food, is transported from the interior of the apparatus, up the auger and out to the outside surface. To this end, a preferable embodiment includes an awning 134 which helps shield the second end before the auger 90 from the elements when the door 132 is open.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. Further, the “invention” as that term is used in this document is what is claimed in the claims of this document. The right to claim elements and/or sub-combinations that are disclosed herein as other inventions in other patent documents is hereby unconditionally reserved.

Having thus described the invention, it is now claimed:

I/We claim:

1. An apparatus comprising:
a) a source of an associated material;
b) a transport means for transporting the associated material from a first location to a second location; and,
c) a controller, said controller operatively associated with said transport means, said controller being controllable by an app on an associated smart phone accessible over a wireless link to a cellular network.

2. A controller, comprising:
a) a timer, said time being remotely programable via an app on an associated smart phone when connected over a wireless link to a cellular network;.

3. The controller of claim 2 further comprising:
a) a speed function, said speed function capable of monitoring a speed of material delivery.

4. The controller of claim 2 further comprising:
a) an environmental function, said environmental function capable of measuring and adjusting to environmental factions.

5. The controller of claim 4 wherein said environmental factors include weather conditions such as whether it is raining.

6. The controller of claim 2 further comprising:
a) a camera function, wherein the controller is capable of taking visual images and video.

7. The controller of claim 2 further comprising:
a) a camera function, wherein the controller is capable of transmitting visual images and video.

8. The controller of claim 2 further comprising:
a) a camera function, wherein the controller is capable of storing visual images and video.

9. A deer feeding apparatus, comprising:
a) a receptacle capable of selectively containing associated deer food;
b) an transport means, said transport means operatively associated with said receptacle and capable of transporting the associated deer food from a first location within the receptacle to a second location outside said receptacle;
c) and,
d) a controller, said controller operatively associated with said motor, said controller being an app on an associated smart phone, said app being selectively connectable to an associated worldwide web and controllable therethrough; said app being able to receive inputs from said apparatus, said inputs including environmental conditions at said apparatus, the level of associated deer food available in said apparatus, live and recorded video of an associated area around said apparatus.

10. A method of remotely feeding deer, said method comprising:
a) filling a receptacle with associated deer food; said receptable having an auger, said auger being operatively associated with said receptacle and being capable of transporting the associated deer food from a first location within the receptacle to a second location outside said receptacle; said auger being operatively associated with an associated motor;
b) monitoring environmental conditions at said apparatus, said environmental conditions including ambient temperature, ambient humidity, live and recorded video, level of remaining food, and the schedule to activate the auger;
c) transmitting said environmental conditions to a controller via a wireless connection; said controller being operatively associated with the associated motor which is associated with said auger, said controller being an app on an associated smart phone, said app being selectively connectable to an associated worldwide web and controllable therethrough; said app being able to receive inputs from said apparatus, said inputs including environmental conditions at said apparatus, the level of associated deer food available in said apparatus, live and recorded video of the area around said apparatus; and,
d) sending a signal from said controller to said motor and thereby rotating said auger whereby rotation of said auger selectively transports the associated deer food from said first location in said receptacle to said second location outside said receptacle.
